(19) United States
(12) Patent Application Publication
(10) Pub. No.: US 2014/0343977 A1
(43) Pub. Date: Nov. 20, 2014

(54) QUEUE REMOTE MANAGEMENT SYSTEM AND METHOD

(71) Applicant: QURAMI S.R.L., Roma (IT)

(72) Inventor: Roberto Macina, Roma (IT)

(73) Assignee: QURAMI S.r.l., Roma (IT)

(21) Appl. No.: 14/354,436

(22) PCT Filed: Oct. 26, 2012
(86) PCT No.: PCT/IB12/55907

§ 371 Date: Apr. 25, 2014

Related U.S. Application Data
(60) Provisional application No. 61/552,770, filed on Oct. 28, 2011.

(51) Int. Cl. G06Q 10/02; H04L 29/08

(52) U.S. Cl. CPC G06Q 10/02; H04L 67/10
USPC 705/5

(57) ABSTRACT

A queue remote management system and a related method are provided, allowing a user to remotely book, receive and manage a ticket for participating to a virtual queue, and finally to receive the call for approaching the counter and the corresponding physical queue, minimizing the time of physical presence at the counter before being provided of the expected service, with integration between conventional ticket machines, operating at different counters and at different entity locations, and a wireless virtual ticket system operated by any user through his personal client terminal, the system comprising: at least one queue management server (100) wherein a plurality of virtual queues are stored and managed, the virtual queues concerning a plurality of counters (102) of one or more entities, each counter (102) being connected to the queue management server (100) to exchange a predetermined information set concerning the call of queue tickets; a plurality of ticket machines (101) physically associated to said counters (102) and issuing physical queue tickets, each ticket machine (101) being connected to the queue management server (100) to exchange a predetermined information set concerning the issue of said physical queue tickets; a plurality of client terminals (103), allowing a user to obtain a virtual queue ticket related to one or more of said counters (102), each client terminal (103) comprising an identification code or an identification certificate allowing to establish a connection to the queue management server (100) to exchange a predetermined information set concerning the status of a user's queue based on both the physical and the virtual tickets, the counters (102), the ticket machines (101) and the client terminal (103) being connected to the at least one queue management server (100) through a communication network, wherein said ticket machines (101), said counters (102) and the at least one queue management server (100) communicate through a corresponding VPN tunnel (104) or through an encrypted web service established in said communication network, the ticket machines (101) and the counters (102) being linked through a dedicated IP address or domain.

### BACKGROUND OF THE INVENTION

1. Field of the Invention

The present invention is related to a system and a method for the remote management of a queueing system, wherein different counters of different entities are managed on the same client terminal, through a computer network. The aim of the system is to allow people to participate to a virtual queue and to physically show themselves at the counter only when their ticket is called, but in the meanwhile without standing in the surroundings of the counter until the ticket is called by a display or by the counter operator.

2. Description of the Prior Art

Other systems for managing a queue are known in the art.

U.S. Pat. No. 6,529,786 discloses a management system wherein portable modules are used to transmit to a person waiting in a virtual queue when to join the physical queue, i.e. when the ticket associated to the queue is about to be called. The managing system is programmed to call the person associated to a given portable module, according to a queue sequence or a serving system. Each portable module has a memory containing a unique identification code, and the presence of the module in proximity of the physical queue is detected at the counter by a module detector.

Such a system allows people to depart from the counter until the ticket is called, but all the people participating to the queue must first to approach the counter to take the designated portable module and then to wait carrying the module, but remaining not too far from the counter. Further, this system requires specially constructed modules associated to that counter, which cannot be used for different entities.

U.S. Pat. No. 6,748,364 discloses a system for assigning and managing reservations for attractions in an amusement park through personal communication devices given to the park guests at the park entrance. The reservation requests are transmitted to a local computer associated to a selected attraction, i.e. to a single counter, determining the expectable waiting time and alerting the guests when the reservation time is approaching.

Again, this system needs special devices, which can be used only within the park using this system.

U.S. Pat. No. 6,845,361 describes a method and a system for maintaining a virtual-wait queue that controls access by customers to a physical resource such as a restaurant table. The method and system are especially adapted for use by customers operating Internet-enabled wireless devices, i.e. smartphones or the like. The system operates by maintaining a virtual-wait queue data structure capable of storing a plurality of entries representative of different customers and system accepts instructions from an I/O main device indicating to either add or delete an entry to the data structure. The main device is located at the premises, i.e. where the service associated to the system is offered. The system also accepts an instruction from a network connection to either add or delete the remote customer into or from the virtual wait queue. The virtual wait queue system indicates to the remote customer the estimated time left in the queue, freeing the customer from the need to wait in line. However, it is apparent that such a management system is capable of maintaining only one wait list through a main device physically placed at said premises.

U.S. Pat. No. 6,889,098 is related to a system for managing the access to an attraction in an amusement park, wherein two kind of queue are provided: a normal queue and a priority queue allowing participants to avoid the normal queue. The system is based on a media distributor thought to provide media entitling the owner to participate to the priority line at a predetermined time, thus allowing him to leave the proximity of the attraction before that time.

In this system, it is intended that the physical distribution of priority passes is requested before participating to the priority queue.

U.S. Pat. No. 7,047,205 is related to a method for loading patrons at multiple attractions in an amusement park, each attraction having a first-in-first-out line and a priority line, wherein mobile phones are used to claim a priority, obtaining in response the time of event access through the priority line.

However, this method appears to be designed only for dedicated attractions, just to create a priority line.

Finally, U.S. Pat. Appl. No. 2011/0307547 discloses a method for generating virtual queues, wherein a bi-directional communication is established between an electronic queue managing system and, on one hand, mobile device of individuals willing to enter the virtual queue and, on the other hand, the entity providing services at the actual queues, allowing also a periodical update of the queue status.

This method is therefore designed to link a single counter according the counter definition given hereinafter and a single user through a bi-directional way, to be replicated for different counters and/or different services.

### SUMMARY OF THE INVENTION

In the following, ticket is meant to be a number or another reference expressing the serving sequence within a queue. The ticket can be virtual, i.e. embodied by a text message on a mobile phone or another mobile device, transmitted through a wireless network like a dedicated cellular network or through the Internet.

Entity is meant to be the provider of services through different counters possibly distributed throughout different locations covering a certain geographical area. The extension of such an area could be undetermined. A number of entity counters may be grouped into an entity location, i.e. an entity office (e.g. a post office, a restaurant, a hospital department, a bank etc.), identified through a physical address and/or other geographical details. Each entity may have different offices covering a certain geographical area.

Counter is generically the physical place wherein the service expected by the queueing people is provided. By way of example, a typical counter is a counter in a postal office, a bank counter, or a table at a restaurant or even a dentist's surgery as well, i.e. any kind of physical place wherein a service is offered to the public.

A counter may be also established by several physical counters placed together in only one location, but all basically providing the same queue with the same services according to one ticket sequence.

At the entity locations, one or more physical queue ticket machines are associated to the operating counters, issuing in turn physical tickets to users directly intervening at the specific location. Both the virtual and the physical tickets participate to a specific virtual queue provided for a counter at a certain location. The virtual queue becomes a physical queue only at the entity premises.

Queue is generally \the assembly of people waiting for the expected service at a generic counter; in a queue a virtual queue is specified, made of people which have booked the expected service but which are waiting to receive a call, just to approach the counter. In contrast, the physical queue is made of people, which is physically present at the counter, waiting to be served. It is understood that a single queue may be associated to several physical counters in a single office, but in such a case said several physical counters, since they are linked by the same location, will be considered as one counter.

A client terminal is any mobile device, which can receive a virtual ticket from the queue management and a subsequent call to approach the counter. In particular, a client terminal is a a mobile device like a smartphone able to connect to a computer network, e.g. the Internet and/or a cellular network, to book and obtain a virtual queue ticket, to receive the final call, and to receive inbetween further information about the queue status, e.g. an alert that only few tickets have to be served before the user's virtual ticket, the expected time of wait, the countdown of the tickets to be served before the user's virtual ticket and other information concerning the queue status. The client terminal may include a positioning system, e.g. a GPS device.

A queue manager is a device, i.e. a server, which can get different counters of different entities and or different offices connected to different client terminals of users willing to benefit of various services offered by said different entities.

According to the above definitions, the object of the invention is to provide a queue management system allowing a user to remotely book, receive and manage a ticket for participating to a virtual queue, and finally to receive the call for approaching the counter and the corresponding physical queue, minimizing the time of physical presence at the counter before being provided of the expected service.

Another object of the invention is to provide integration between conventional ticket machines, operating at different counters and at different entity locations, and a wireless virtual ticket system operated by any user through his personal client terminal.

In accordance with exemplary embodiments of the present invention a novel queue remote management system comprises at least one queue management server wherein a plurality of virtual queues are stored and managed, the virtual queues concerning a plurality of counters of one or more entities, each counter being connected to the queue management server to exchange a predetermined information set concerning the call of queue tickets.

The above management systems also comprises a plurality of ticket machines physically associated to said counters and issuing physical queue tickets, each machine being connected to the queue management server to exchange a predetermined information set concerning the issue of said physical queue tickets.

The system is further connected to a plurality of client terminals, allowing a user to obtain a virtual queue ticket related to one or more of said counters; each client terminal comprises an identification code or an identification certificate allowing to establish a connection to the queue management server to exchange a predetermined information set concerning the status of a user's queue based on both the physical and the virtual tickets. Through this channel, the queue status is updated at the client terminal.

According to a preferred embodiment, the client terminals comprise Internet-able mobile devices such as mobile phones, smartphones and the like, possibly including also a positioning system like GPS, intended to localize the user with respect to his expected counter.

According to the invention, the counters, the ticket machines and the client terminal are connected to the at least one queue management server through a communication network, i.e. possibly the Internet. In this regard, said ticket machines, said counters and said at least one queue management server communicates each other through corresponding VPN tunnels, established in said communication network, or through an encrypted web service, and both the ticket machines and the counters are linked through a dedicated IP address or domain.

It is clearly intended that ticket machines and/or counter may either be directly connected to the queue management server (see FIG. 1), or connected to a local server grouping them with a single IP address, this server being in turn connected to said queue management server (see FIG. 2 or 3).

According to further details of the preferred embodiments, in the queue remote management system according to the invention said ticket machines, said counters, said client terminals and the at least one queue management server communicates to each other according to an instant messaging protocol in a push mode, possibly an extensible messaging and presence protocol (XMPP).

According to the same inventive concept, the present invention is also referred to a queue remote management method using at least one queue management server wherein a plurality of virtual queues are stored and managed, the virtual queues concerning a plurality of counters of one or more entities.

According to the method of the invention, each counter is connected to the queue management server to exchange a predetermined information set concerning the call of queue tickets; then a plurality of ticket machines, physically associated to said counters and issuing physical queue tickets, is connected to the queue management server to exchange a predetermined information set concerning the issue of said physical queue tickets; and a plurality of client terminals, each comprising an identification code or an identification certificate, is connected to the queue management server to obtain virtual queue tickets related to one or more of said counters upon a user's request and to exchange with the queue management server a predetermined information set concerning the status of a user's queue based on both the physical and the virtual tickets.

In accordance with the method of the invention, the counters, the ticket machines and the client terminal are all connected to the at least one queue management server through a communication network, and the connection between said ticket machines, said counters and the at least one queue management server is established through corresponding VPN tunnels in said communication network, the ticket machines and the counters being linked through a dedicated IP address or domain.

### BRIEF DESCRIPTION OF THE DRAWINGS

Other objects and advantages of the present invention will become apparent to those skilled in the art from the following detailed description of preferred embodiments, when read in conjunction with the accompanying drawings, wherein:

FIG. 1 is a schematic view showing a queue remote management system according to a first embodiment of the present invention;

FIG. 2 is a schematic view showing a queue remote management system according to a second embodiment of the present invention;

FIG. 3 is a simplified view showing the architecture of an alternative embodiment of a queue remote management system according to the present invention;

FIG. 4 is a view of a smartphone display acting as a client terminal in the queue remote management system according to the present invention, in which an operation step is shown;

FIG. 5 is a view of a smartphone display acting as a client terminal in the queue remote management system according to the present invention, in which another operation step is shown;

FIG. 6 is a view of a smartphone display acting as a client terminal in the queue remote management system according to the present invention, in which a further operation step is shown;

FIG. 7 is a view of a smartphone display acting as a client terminal in the queue remote management system according to the present invention, in which a further operation step is shown;

FIG. 8 is a view of a smartphone display acting as a client terminal in the queue remote management system according to the present invention, in which a further operation step is shown;

FIG. 9 is a view of a smartphone display acting as a client terminal in the queue remote management system according to the present invention, in which a further operation step is shown;

FIG. 10 is a diagram wherein a step of the queue remote management method according to the invention is illustrated;

FIG. 11 is a diagram wherein a subsequent step of the queue remote management method according to the invention is illustrated; and

FIG. 12 is a diagram wherein a further step of the queue remote management method according to the invention is illustrated;

### DETAILED DESCRIPTION OF THE INVENTION

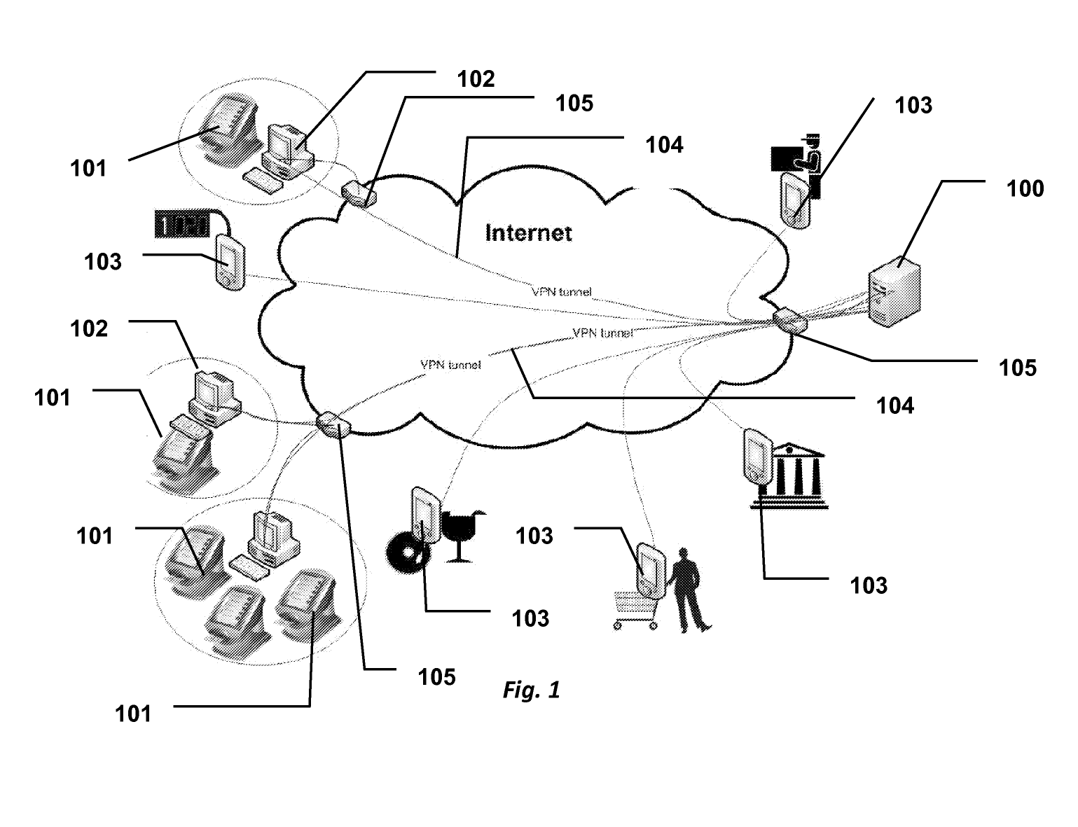

With reference to FIG. 1, a system for the remote management of queues is there illustrated.

It comprises a queue management server 100 which is connected to the Internet; this server is used to store and manage a plurality of virtual queues. It should be noted that different queues are referred to respective counters.

The nature of the counters can vary in an unlimited range, from post office or bank counters to the tables of restaurants, from any kind of surgery in a hospital to the cashier of a supermarket, from an attraction in a park to a place in a parking area, from a car repair shop to a scheduled visit in a museum. It is understood that this list of possible counters is only exemplificative and non-exhaustive.

It is also understood that several counters offering the same service at the same place would be considered as a single counter. In contrast, a single location, i.e. an office or a restaurant, may include many different counters each corresponding to a different service. In many cases but not in all cases, the singularity of a counter is given by its nature: a table at a restaurant with a certain number of chairs, an attraction in a park and so on.

Each queue managed by the server can be divided in two distinct parts: the virtual one, made by people who remotely asked for receiving a virtual queue ticket; an the physical one, wherein people waiting has obtained a physical queue ticket from a queue ticket machine, i.e. a ticket dispenser electronically connected to a counting and call display associated to a specific counter.

In any case, each counter as above defined is connected to the queue management server to exchange a predetermined information set concerning the call of queue tickets, i.e. the ticket which is currently served, the tickets to be served next and possibly the waiting time for the last issued ticket. These details are updated at the location of the counter, to inform people waiting there.

In this connection, the queue management system includes a plurality of ticket machines 101 which are physically associated to said counters. These machines, possibly more than one for a single counter or a single one serving tickets for different queues, issues physical queue tickets.

Each ticket machine 101 is directly or indirectly connected to the queue management server 100 to exchange predetermined information set concerning the issue of said physical queue tickets. Also the counters are identified by an I/O device, typically a PC indicated as 102, which are directly or indirectly connected to the queue management server 100 as above explained.

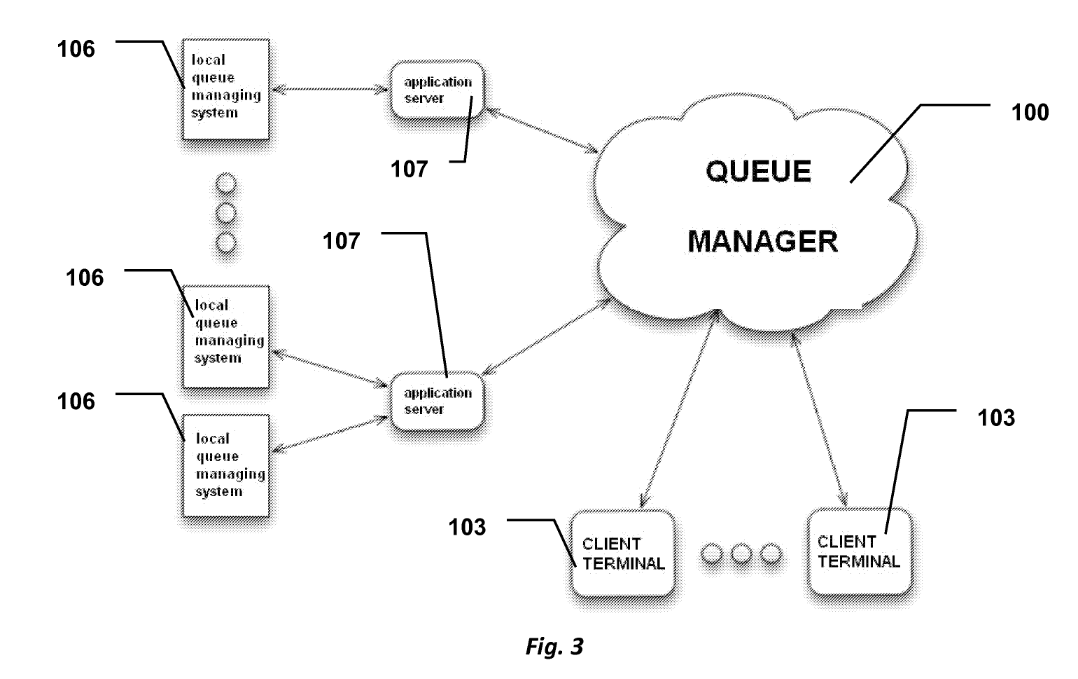

According to FIG. 3, an alternative architecture is shown, wherein the system is made of four main components: a set of mobile clients that allow end users to interact with the system; a middleware directly connected to a single queuing management system or group of them to allow the communication with the queue management server; a set of distributed services 107 acting as queue server manager, which aggregates information on the queuing systems collected through the queue applications and provides information upon request to the client.

Then, counters and ticket machines may form a local queue managing system 106, thus identifying a single local system for each counter, i.e. for each service provided at certain premises. All the systems belonging to a single premise, possibly according to a scheme repeated for each premise of a complex entity (e.g. the post organization, a bank with several branches, a delivery service with several delivery points etc.), are connected to a local application server 107, which in turn is connected to the queue management server according to the invention.

Further the remote queue management system comprises a plurality of client terminals 103, allowing a user to obtain a virtual queue ticket related to one or more of said counters, chosen through a dedicated application loaded onto the client terminal or through a web interface.

In this connection, each client terminal 103 is distinguished by an identification code or an identification certificate allowing to establish a connection to the queue management server to exchange a predetermined information set concerning the status of a user's queue based on both the physical and the virtual tickets.

The identification code could be operated by a login and a password, or by a PIN instantly generated by the system itself. Again, a personal identification certificate could be a software key loaded onto the terminal client, or a SIM inside the terminal or a phone number associated to the terminal.

It is apparent that the client terminal may be embodied by a mobile phone, a smartphone, a PDA or a tablet connected to the Internet, a PC or a notebook and so on. In general terms, client terminal identifies either an Internet-able mobile device or a desk device, i.e. a PC, connected to the Internet.

Finally, it is understood that all the counters 102, the ticket machines 101 and the client terminal 103 are connected to at least one queue management server 100 through a communication network, possibly the Internet.

According to the invention, said ticket machines 101 and said counters 102 communicate according to a bi-directional way to said at least one queue management server 100 through corresponding VPN tunnels 104 established in said communication network. To this purpose, the ticket machines 101 and the counters 102 must be linked through a dedicated IP address 105 or domain.

In other words, the connection between said ticket machines, said counters and the at least one queue management server is established through corresponding VPN tunnels 104 in the Internet, the ticket machines and the counters being linked through a dedicated IP address or domain.

According to the preferred embodiments, the above communication is performed according to an instant messaging protocol in a push mode having an asynchronous activity, preferably through an extensible messaging and presence protocol (XMPP).

In order to realize this kind of connection, a small queue application is directly installed in each ticket machine and in any counter, or in the local application server linking one or several local queue managing systems. The same possibly applies to any kind of client device apt to directly access the queue management server.

If the queue application is written in Java® language, it is sufficient that any involved machine have Java®Virtual Machine installed therein. In this way, the installation is completely independent upon the operating system of the client device, thus requiring no special privileges but a single public IP address or a dedicated domain to access the queue management server 100.

When a new virtual queue ticket is delivered, the system is designed to provide the client terminal corresponding to that new ticket with information details concerning the queue status, thus enabling the virtualization of the physical process of printing and delivery of the paper ticket. This process is fully integrated with the service of issuing physical queue tickets at the premises of the desired counter.

Through a client terminal is also possible to delete or postpone a virtual queue ticket, generating an update of the whole system.

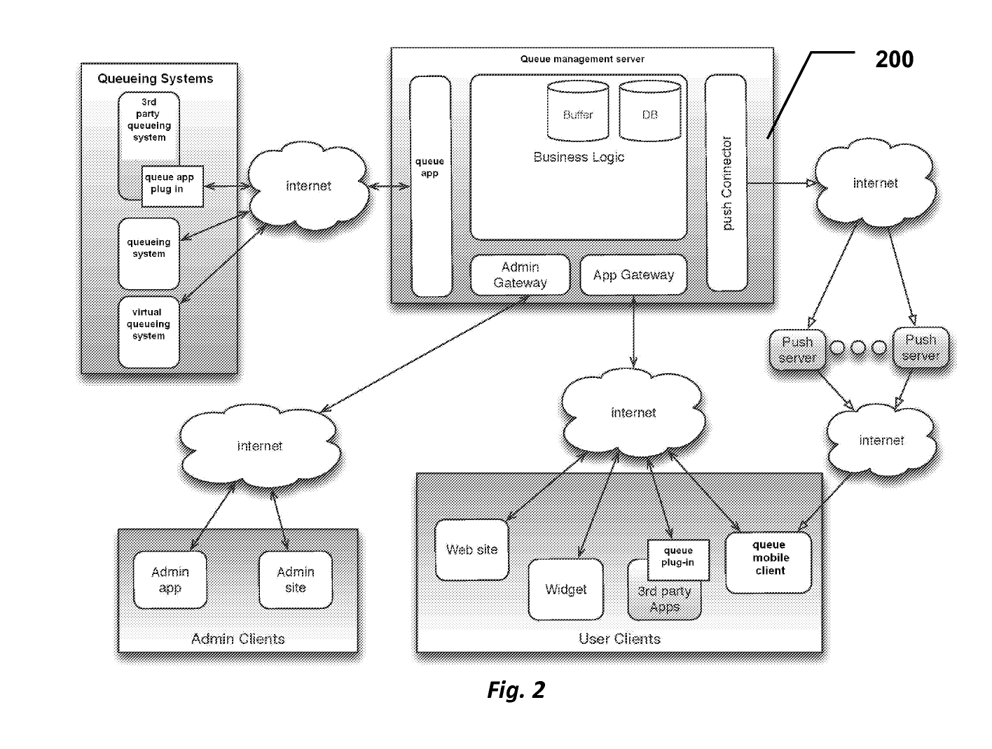

With reference to FIG. 2, a second embodiment of the invention is shown, wherein WPN tunnels are replaced by a conventional web service connection but provided with a suitable encryption. to keep unaltered the performances in comparison with the previous embodiment in terms of safety.

Here, the queue management server 200 can be contacted by a user through a ticket machine, a web application interface or a mobile queue client. The latter can bi-directionally communicate with the queue management server in a push mode through a XMPP protocol, allowing a push communication with no server elements.

If corporate networks are equipped with firewalls and/or proxy server, and these components do not support the XMPP protocol, the system is designed to receive calls from the queue server according to a polling HTTP but in any case all communications are directed to a single public IP address or a dedicated domain.

The information obtained from the clients is sent to the queue management server with simple HTTP calls. The server provides a private REST (REpresentational State Transfer) API that allows the total management of all the information related to the queuing system. If, for reasons related to safety and control, the need arises of concentrating all the communications into a single proprietary structure and from there to our systems, the system is already designed to provide the possibility of a centralized interface.

Upon request of a ticket by the mobile client, the queues management server sends an XMPP message which is received asynchronously. The request is decoded, interpreted, and forwarded to a local queuing system, the latter's reply is formatted, enriched, always encrypted and asynchronously sent back to the queue management server for of notifying the response information to the mobile client.

If the XMPP protocol is not available, the queue application performs queries by polling once per second to the HTTP service, which acts as a proxy for XMPP messages. The messages are then processed one by one with the above procedure. A similar procedure is implemented for the cancellation of the ticket.

The standard configuration is modifiable according to defined parameters and it provides for the interrogation of the queue management system by the QSync every 5 seconds.

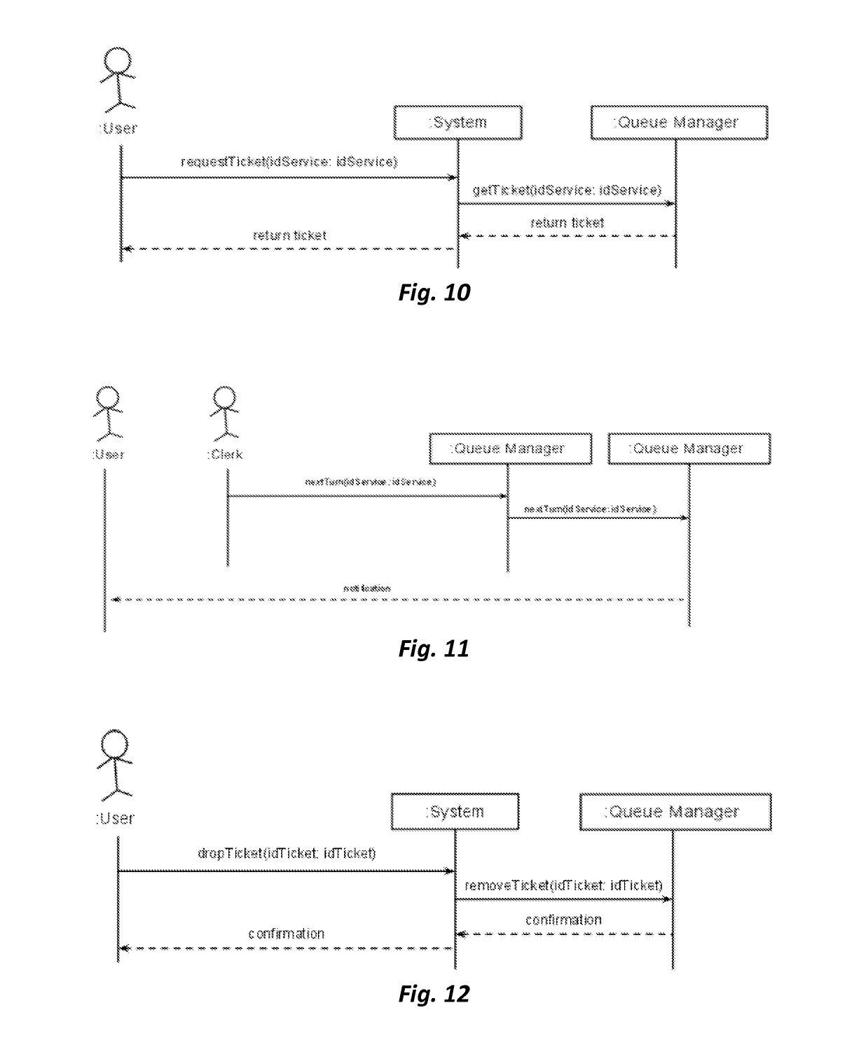

Given the nature of the networks wherein the queuing systems usually operate and not having the possibility to exert any kind of control over said queuing systems, it is assumed that a secure local communication between local queueing systems and the queue server manager is available. As a matter of fact, this communication is non-encrypted on the HTTP protocol. The process of requesting a virtual ticket is summarized in FIG. 10. A user sends a request to the queue management server (:System) which contacts the server at the counter (:Queue Manager) and then receives a virtual ticket in return, transmitting it to the user (dotted line).

With reference to FIG. 11, when the operator (:Clerk) calls the user at the venue, an alert is sent to the next user in the line. With reference to FIG. 12, if the user decides to drop the ticket, the reverse path shown in FIG. 10 is followed.

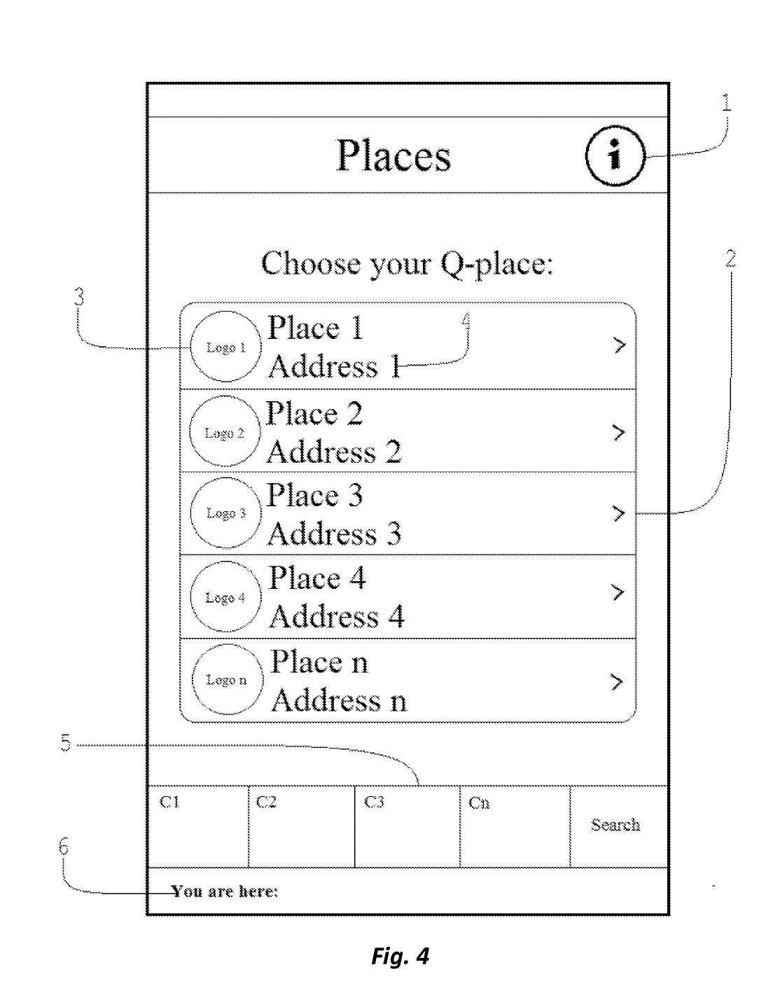

According to FIG. 4, the client terminal interface, here shown as a touch screen of a smartphone, comprises a general terms and conditions, contacts, and privacy button 1, a geo-localization box 2 completed with venue logos 3, venue name and address 4. Then the interface comprises a general tab bar 5 to browse categories and a geo-localization display 6 subject to client rules. This interface allows the user to choose the desired venue for receiving a service through a counter connected to the system just tapping the venue logo 3 at the chosen address 4.

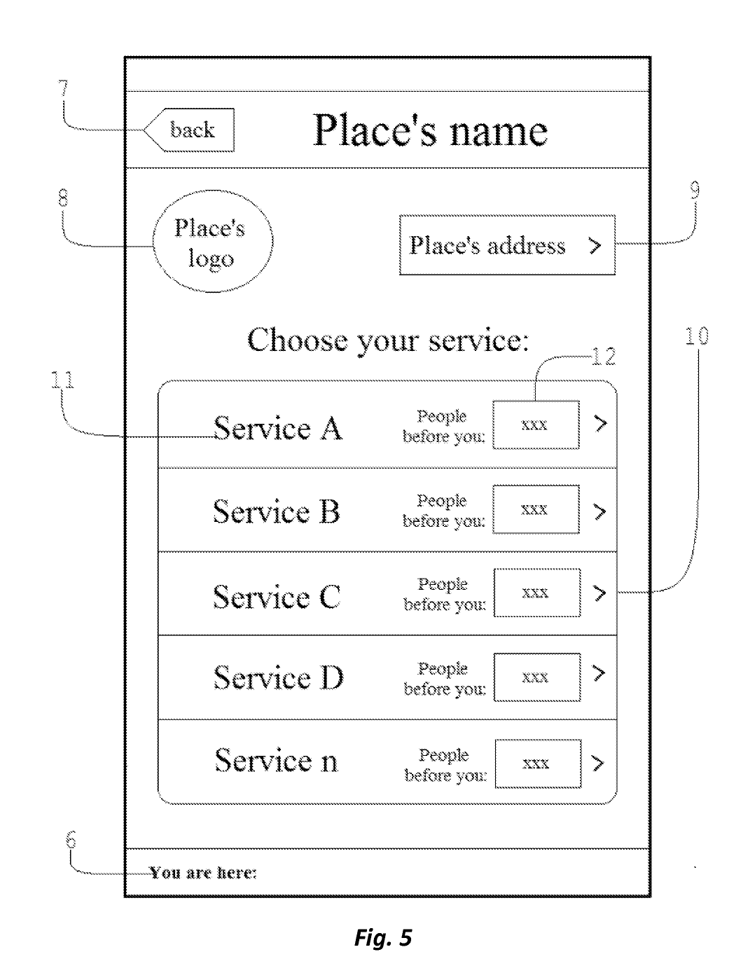

According to FIG. 5, the next screen of the interface comprise a back button 7, a venue logo 8, a venue address 9, a list 10 of available services at the selected venue, each indicated by a service name 11. For each service, a real time notification 12 about the number of people in line is available.

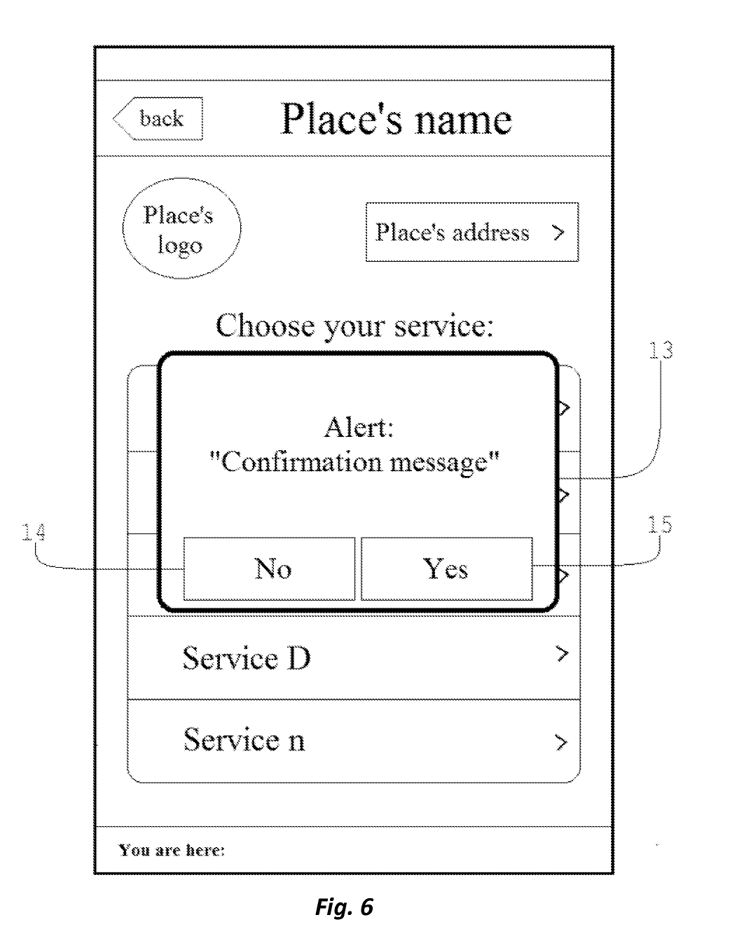

The choice of the service is performed by tapping the service name 11. After (FIG. 6) a confirmation box 13 would appear, with a “Cancel your ticket” option 14 and a “Confirmation of ticket request” option 15.

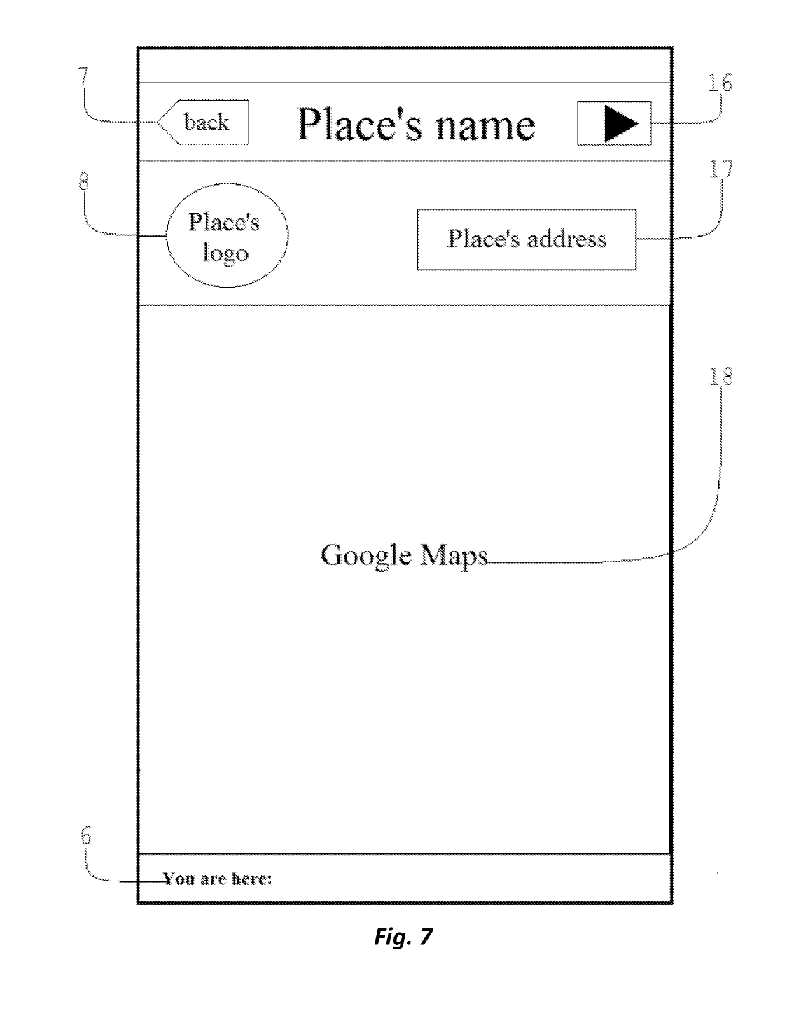

Instead, tapping the venue address 9 in FIG. 5 would lead the screen of FIG. 7 to appear, where a navigation button 16 is available, together with a venue address 17, and a map representation 18 (exemplarily, a Google® map screen).

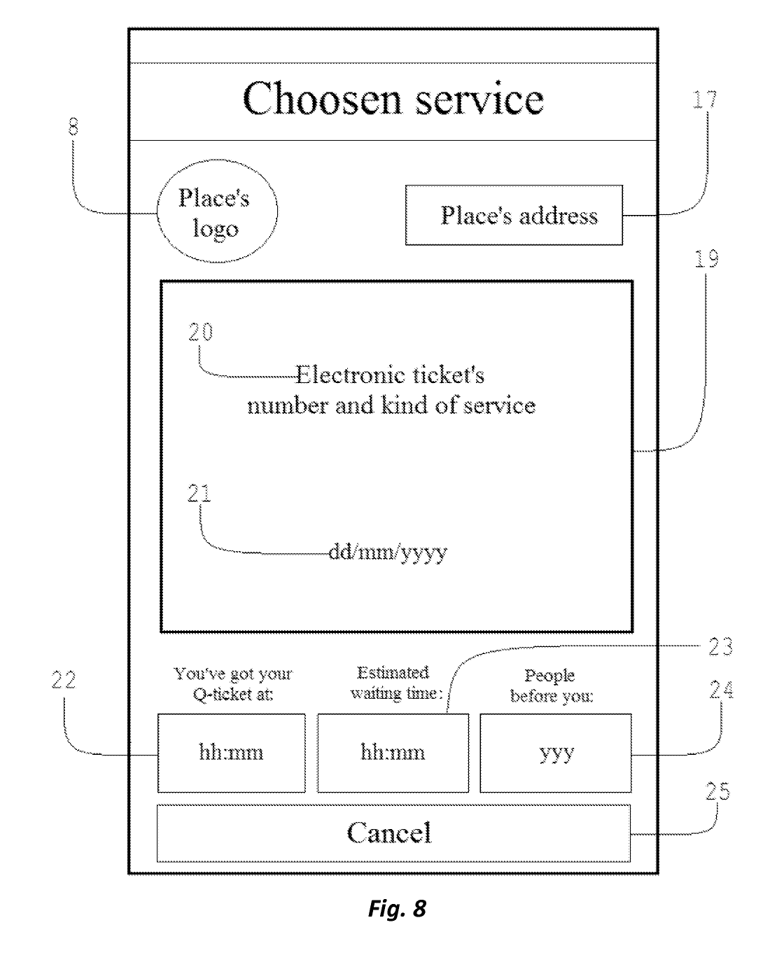

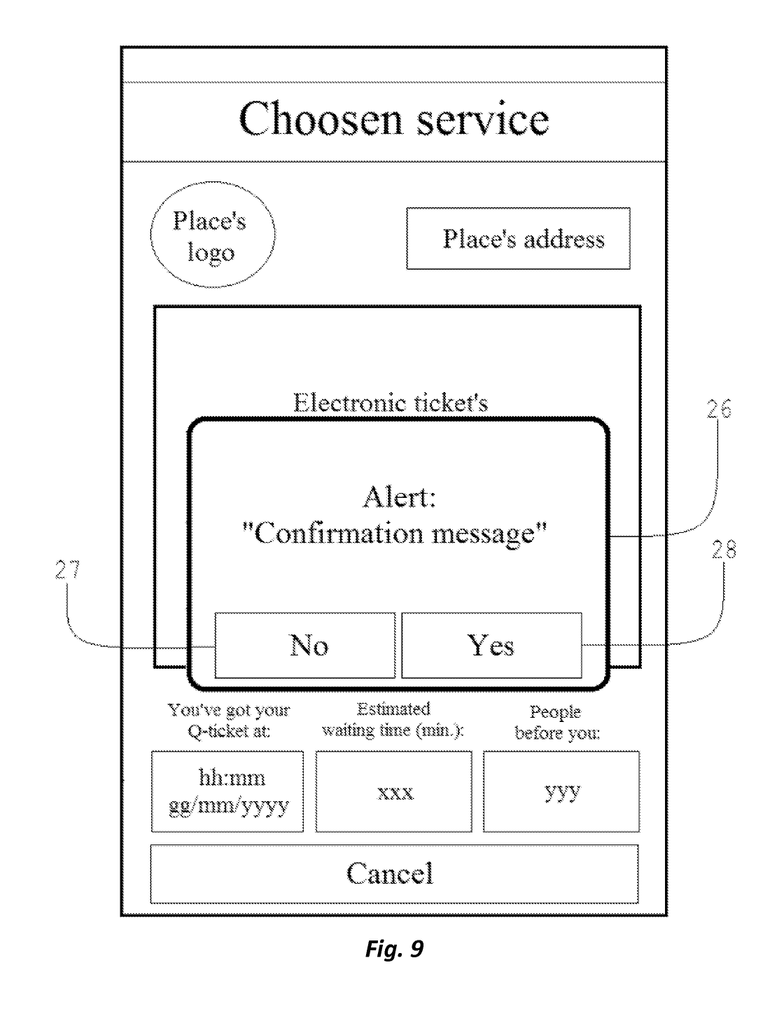

By tapping the confirmation button 15 of FIG. 6, the screen of FIG. 8 would appear, wherein a virtual ticket or a e-ticket details box 19 is available, with the indication of the selected service 20 and the virtual ticket number of a serving sequence, with the ticket request date 21. Below, the estimated time 22 for being served is available, together with the estimated wait time 23 and the real time information concerning the number of users 24 before the received ticket. The transaction may be cancelled by a Cancel button 25. Tapping the latter button would lead to the screen of FIG. 9, where a confirmation box 26 appear, with the “Confirm Cancellation” option 28 and the “Dismiss” option 27.

In a further embodiment of the invention, the client terminal 103 in the form of Internet-able mobile devices (smartphones etc.) can comprise a positioning system, namely a GPS antenna and related software.

In this connection, the issue of a virtual ticket could happen according to the instant geographical location of the mobile device at the request moment, with the choice of the user's more easily reachable counter among those available for the service requested. Such a choice may take into account also the road distance and possibly the currently available traffic data, computing the travel time T₁ in comparison with the expected wait time T₂, issuing a virtual ticket according the condition T₂ >T₁.

Then, the instant position of the mobile device is monitored in the queue management server through an instant geo-localization process, in relationship with a queue status at the chosen counter, to possibly and automatically postpone the participation of the user to the actual queue issuing a new virtual ticket and updating the queue status accordingly.

Beside the mentioned benefits for the end user, the proposed system and method offer two measurable and relevant advantages: eco-sustainability in terms of paper usage reduction and processing time reduction.

A number of embodiments of the invention have been described. Nevertheless, it will be understood that various modifications may be made without departing from the protection scope of the invention as defined by the annexed claims.

1. A queue remote management system comprising:
at least one queue management server (100) wherein a plurality of virtual queues are stored and managed, the virtual queues concerning a plurality of counters (102) of one or more entities, each counter (102) being connected to the queue management server (100) to exchange a predetermined information set concerning the call of queue tickets;
a plurality of ticket machines (101) physically associated to said counters (102) and issuing physical queue tickets, each ticket machine(101) being connected to the queue management server (100) to exchange a predetermined information set concerning the issue of said physical queue tickets;
a plurality of client terminals (103), allowing a user to obtain a virtual queue ticket related to one or more of said counters (102), each client terminal (103) comprising an identification code or an identification certificate allowing to establish a connection to the queue management server (100) to exchange a predetermined information set concerning the status of a user's queue based on both the physical and the virtual tickets,
the counters (102), the ticket machines (101) and the client terminal (103) being connected to the at least one queue management server (100) through a communication network, said ticket machines (101), said counters(102) and the at least one queue management server (100) communicate through a corresponding VPN tunnel (104) or through an encrypted web service established in said communication network, the ticket machines (101) and the counters (102) being linked through a dedicated IP address or domain.

2. The queue remote management system according to claim 1, wherein said communication network is the Internet and wherein said ticket machines (101), said counters (102), said client terminals (103) and the at least one queue management server (103) communicate to each other according to an instant messaging protocol in a push mode.

3. The queue remote management system according to claim 2, wherein said ticket machines (101), said counters (102), said client terminals (103) and the at least one queue management server (104) communicates through an extensible messaging and presence protocol (XMPP).

4. The queue remote management system according to claim 2, wherein the client terminals (103) comprise Internet accessible mobile devices.

5. The queue remote management system according to claim 4, wherein said Internet accessible mobile devices comprise a positioning system, said virtual ticket being issued according to the geographical location of the mobile device and of a user's more easily reachable counter.

6. The queue remote management system according to claim 5, wherein the instant position of the mobile device is monitored in the queue management server in relationship with a queue status at the virtual ticket counter, to possibly and automatically postpone the participation of the user to the actual queue issuing a new virtual ticket and updating the queue status accordingly.

7. A queue remote management method using at least one queue management server wherein a plurality of virtual queues are stored and managed, the virtual queues concerning a plurality of counters of one or more entities, wherein:
each counter is connected to the queue management server to exchange a predetermined information set concerning the call of queue tickets;
a plurality of ticket machines, physically associated to said counters and issuing physical queue tickets, is connected to the queue management server to exchange a predetermined information set concerning the issue of said physical queue tickets;
a plurality of client terminals, each comprising an identification code or an identification certificate, is connected to the queue management server to obtain virtual queue tickets related to one or more of said counters upon a user's request and to exchange with the queue management server a predetermined information set concerning the status of a user's queue based on both the physical and the virtual tickets,
the counters, the ticket machines and the client terminal being connected to the at least one queue management server through a communication network, the connection between said ticket machines, said counters and the at least one queue management server is established through corresponding VPN tunnels or through an encrypted web service in said communication network, the ticket machines and the counters being linked through a dedicated IP address or domain.

8. The queue remote management method according to claim 7, wherein said communication network is the Internet and wherein said connection is established according to an instant messaging protocol in a push mode.

9. The queue remote management method according to claim 8, wherein said connection is established according to an extensible messaging and presence protocol (XMPP).

10. The queue remote management method according to claim 8, wherein the client terminals comprise Internet accessible mobile devices.

11. The queue remote management method according to claim 10, wherein said Internet accessible mobile devices comprise a positioning system, said virtual ticket being issued according to the geographical location of the mobile device and of a user's more easily reachable counter.

12. The queue remote management method according to claim 11, wherein the instant position of the mobile device is monitored in the queue management server in relationship with a queue status at the virtual ticket counter, to possibly and automatically postpone the participation of the user to the actual queue issuing a new virtual ticket and updating the queue status accordingly.
